(19) United States
(12) Patent Application Publication
(10) Pub. No.: US 2007/0158125 A1
(43) Pub. Date: Jul. 12, 2007

(54) Driver assistance system having a function blocking device

(76) Inventors: Goetz Braeuchle, Reichartshausen (DE); Carsten Schroeder, Renningen (DE); Peter Petschnigg, Stuttgart (DE)

Correspondence Address: KENYON & KENYON LLP, ONE BROADWAY, NEW YORK, NY, 10004, US

(21) Appl. No.: 10/567,715

(22) PCT Filed: Jul. 22, 2004
(86) PCT No.: PCT/DE04/01608

§ 371 Date: Sep. 29, 2006

(30) Foreign Application Priority Data
Aug. 7, 2003 (DE) 103 36 333.5

(51) Int. Cl. B60T 7/16

(52) U.S. Cl. 180/167

(57) ABSTRACT

A driver assistance system for motor vehicles, having at least one assistance function that is to be used only under particular preconditions, characterized by an acquisition device for acquiring data concerning the locality in which the vehicle is traveling, and by a blocking device for blocking the assistance function if the acquired data indicate that the preconditions for the use of the assistance function are not met.

### FIELD OF THE INVENTION

The present invention relates to a driver assistance system for motor vehicles, having at least one assistance function that is to be used only under particular conditions.

### BACKGROUND INFORMATION

Motor vehicles are increasingly equipped with driver assistance systems that support the driver in the driving of the motor vehicle. An example of such a driver assistance system that is already commercially available is a system for adaptive distance and speed control (ACC: Adaptive Cruise Control), which is provided for use on highways and well-structured roads, and which makes it possible, for example with the aid of a radar system, to locate vehicles traveling in front of the home vehicle and to adapt the speed of the home vehicle in such a way that the vehicle traveling in front is followed at a suitable distance, or, if no vehicle traveling in front is located, to control the speed of the home vehicle to a desired speed selected by the driver. Such systems are not yet suitable for use on poorly constructed roads or in city traffic, because in city traffic, with its more complex conditions, a more expensive sensory mechanism is required for the acquisition of the traffic situation. The known ACC systems are therefore intended for use only at higher speeds, for example at speeds greater than 30 km/h.

However, attempts are being made to expand the area of application of such assistance functions to more complex traffic situations. Thus, for example ACC systems are currently being developed that have, as an expanded function, what is known as an LSF (Low Speed Following) function that can be used for an expanded range of speeds, down to a standstill of the vehicle. In this way, for example in stalled traffic on a highway or on a well-structured country road, the possibility is created, in congested traffic or when approaching the end of a traffic jam, of reducing the speed of the home vehicle below the limit of 30 km/h, and of braking the vehicle to a standstill if necessary, if the vehicle in front comes to a stop. If, after a brief stop, the vehicle in front starts to move again, this function should for example also be able to control the resumption of movement of the home vehicle. However, this function is not yet suitable for use in city traffic, for example.

The complex environment of city streets, with streetlights, intersections, parking vehicles, pedestrians, etc., cannot be satisfactorily acquired with the sensor technology currently in use. Depending on the situation, the use of the LSF function in these situations can result in false reactions, for example in the form of a lack of reaction to relevant obstacles or in the form of an unnecessary reaction to seeming obstacles acquired by the radar system.

Therefore, preventive measures should be taken for the case in which the driver misuses this LSF function in situations in which the preconditions for the reliable operation of the function are not met, or in which the driver, for example, neglects to deactivate the function when entering a built-up area.

### SUMMARY OF THE INVENTION

The invention offers the advantage that an assistance function, for example the LSF function named above, is automatically blocked if clear indications are present that the preconditions for the appropriate operation of these functions are not met. For the recognition of such indications, the driver assistance system according to the present invention has an acquisition device that acquires data concerning the locality in which the vehicle is currently situated. On the basis of these data, the system can for example recognize that the vehicle is traveling in a built-up area, or, more generally, is situated in an environment in which the relevant assistance function should not be used. A blocking device than ensures that the assistance function cannot be activated by the driver under these conditions, and/or that the function is automatically deactivated if it is still active. In this way, the present invention offers on the one hand an increased level of convenience by making the assistance function available under conditions that are suitable for its use, while on the other hand contributing to an increase in traffic safety by preventing the function from operating under unsuitable conditions. At the same time, the system behavior becomes more transparent for the driver.

The acquisition device can for example be formed by a navigation system or by an interface to a navigation system, which is often already present in the vehicle. Known navigation systems provide information concerning the current location of the vehicle, as well as information concerning the road network and street routes, in the form of a stored map. In known navigation systems the perimeters of built-up areas are often already marked in the stored map, so that the navigation system can provide the blocking device with the information that the vehicle is located in a built-up area.

Optionally, the acquisition device can also have a separate system for evaluating the movement of the home vehicle, or can be formed by such a system.

Particularly advantageously, the present invention is in combination with what is known as an intelligent navigation system, which, in addition to location information and information about the road network, also provides information about characteristics of the roadway, such as information about the lanes, speed limits, and the like. This information enables a still more precise classification of the current traffic environment, thus making it possible, for example, to cancel the blocking of the assistance function on high-speed roadways within a city.

Alternatively, or in addition, the acquisition system can also have a receiving device for telematics data. In this case, the information about the type of street, required for the decision as to whether the assistance function can be used or not, is provided by a telematics service provider, for example in wireless fashion via radio beacon, so that it can be received and evaluated by the receiving device of the vehicle. Such a receiving device can also be combined with an intelligent navigation system, and can then for example also be used to download the roadway characteristics and other local information to the intelligent navigation system as needed.

According to a further specific embodiment of the present invention, the acquisition device is formed by a suitable video sensor apparatus, for example at least one video camera and an associated image recognition electronics system, capable of recognizing traffic signs, town signs, and the like. The recognition of town entry and town exit signs is then used to control the blocking device. At the same time, this video sensor apparatus also recognizes traffic regulation signs, such as speed limits and the like, and automatically takes them into account in speed regulation in the context of the assistance function.

If, through the recognition of a town entry sign, entry into a built-up area is detected, this information is preferably stored in a non-volatile memory, so that it is still available even after a temporary switching off of the vehicle ignition. In this way, the assistance function also remains blocked even after an interruption of the trip, until a town exit sign is recognized. Depending on the specific embodiment, it can be provided that the blocking can be canceled by an active intervention of the driver, or not. In the latter version, the driver can override the block after having taken note of a signal that the system has recognized a state in which the preconditions of use are not met. The block and the signal then have only a warning function, while the final decision, and the responsibility, remain with the driver. An advantage of this version is the greater ease of canceling false evaluations, for example if a town exit sign is not recognized.

### BRIEF DESCRIPTION OF THE DRAWINGS

FIG. 1 shows a block diagram of a driver assistance system according to the present invention.

FIG. 2 shows a block diagram of a driver assistance system according to a modified specific embodiment.

### DETAILED DESCRIPTION

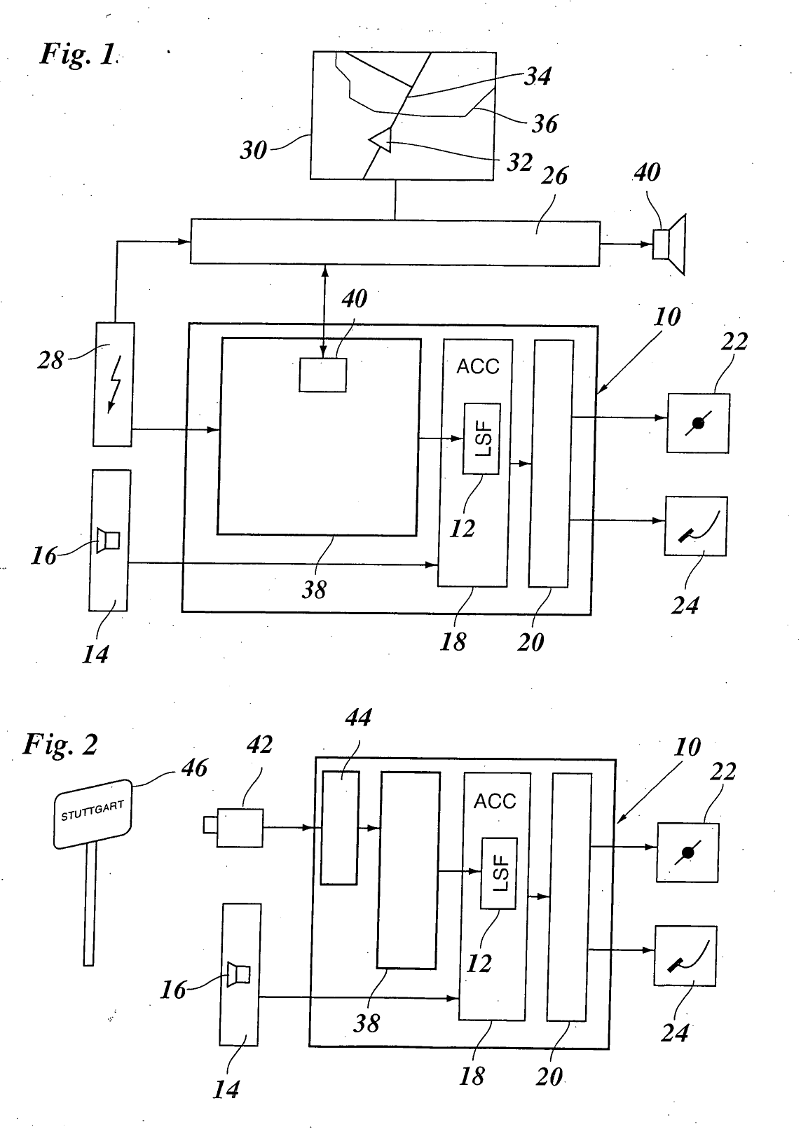

The driver assistance system for a motor vehicle, shown as a block diagram in FIG. 1, has an ACC control unit 10 in which, besides the known ACC function for higher speeds, an LSF (Low Speed Following) function 12 for lower speeds has also been implemented. The functions of the ACC control unit are for example executed by one or more suitably programmed microprocessors. A sensor device 14 is allocated to ACC control unit 10; this sensor device has at least one location sensor, for example a radar sensor 16, for locating vehicles traveling in front of the home vehicle, as well as additional sensors (not shown in more detail) for acquiring longitudinal speed, yaw rate, and other relevant data relating to the movement of the home vehicle. The location data of sensor device 14 are processed in a known manner in an ACC controller 18, which acts on drive system 22 and brake system 24 of the vehicle via a command output unit 20.

In addition, an acquisition device for acquiring data concerning the current environment of the motor vehicle is allocated to ACC control unit 10. In the example shown, this acquisition device is formed by an intelligent navigation system 26 having a telematics receiver device 28.

Navigation system 26 contains, in a known manner, a data carrier (not shown in more detail) on which there is stored map information about the road network. A corresponding map segment can be displayed on a display screen 30. The navigation system also includes a positioning system, for example a satellite-supported positioning system (GPS; Global Positioning System), with which the current position of the home vehicle can be determined. The vehicle position is indicated on display screen 30 by a position indicator 32, which at the same time indicates the current direction of travel. In addition, on the display screen the routes of streets 34, as well as the perimeter 36 of a built-up area, can be seen.

In addition to the information about the road network, on the data carrier of the navigation system there are also stored roadway characteristics such as the width of the roadway, the number of lanes, one-way street regulations, whether a road is local (within a city) or regional, speed limits, prohibitions on passing, and the like.

Telematics receiving device 28 enables the wireless reception of messages from a telematics service provider, for example a traffic guidance system. These messages can in particular also provide information as to whether the locality in which the vehicle is currently situated is suitable for the use of LSF function 12 or not. This information can either be evaluated directly in ACC control unit 10, or can be used to update the roadway characteristics in navigation system 26.

ACC control unit 10 has a blocking device 38 that is used to block the LSF function if the locality in which the vehicle is situated is not suitable for the use of this function. For this purpose, blocking device 38 evaluates the information provided by telematics receiver device 28, and is in addition connected to navigation system 26 via an interface 40, so that it can also access the information that is available in the navigation system. In this way, blocking system 38 can also determine, on the basis of the roadway characteristics and/or perimeter line 36 of built-up areas stored in the navigation system, whether the preconditions for the use of the LSF function are met.

The driver assistance system can be operated by the driver via a human-machine interface that is known and is not shown here. This interface includes at least one switch for activating the ACC function and/or the LSF function, as well as display lights that indicate which of these functions is active or can be activated. If blocking device 38 determines that the preconditions for the LSF function are not present, it prevents the driver from activating the LSF function, and the corresponding display light is turned off. If the driver nonetheless attempts to activate the LSF function, the driver assistance system indicates that this function currently cannot be activated. For this indication, for example a voice output system 40 of navigation system 26 can be used.

If the LSF function is active and blocking device 38 then recognizes that the preconditions for this function are no longer present, voice output system 40 issues a takeover request to the driver, indicating to the driver that the LSF function is no longer available and that the driver must himself take over control of the vehicle. After a time delay, the LSF function is then automatically deactivated.

FIG. 2 shows a modified specific embodiment in which the acquisition device for acquiring data concerning the locality is formed by a video camera 42 having an associated image recognition unit 44. Image recognition unit 44 is fashioned such that it can recognize traffic signs, including town entry and exit signs. If a town entry sign 46 is detected in this way, for example upon entry into a built-up area, the LSF function is thereupon blocked by blocking device 38. The blocking is canceled as soon as the video sensor apparatus recognizes a town exit sign.

1.-7. (canceled)

8. A driver assistance system for a motor vehicle, comprising:
an arrangement for providing at least one assistance function that is to be used only under a particular precondition;
an acquisition device for acquiring data concerning a locality in which the vehicle is traveling; and
a blocking device for blocking the assistance function if the acquired data indicates that the precondition is not met.

9. The driver assistance system as recited in claim 8, wherein:
the assistance function is a low speed following function that controls the vehicle in such a way that the vehicle follows another vehicle traveling in front at a suitable distance, and
the assistance function is also capable of being used at speeds below 30 km/h if a local condition allows this.

10. The driver assistance system as recited in claim 9, wherein:
the assistance function brakes the vehicle automatically to a standstill if the other vehicle traveling in front comes to a stop.

11. The driver assistance system as recited in claim 8, wherein the acquisition device includes a navigation system.

12. The driver assistance system as recited in claim 11, wherein:
the navigation system includes an intelligent navigation system in which roadway characteristics are stored that indicate whether the precondition for the assistance function is met on a respective roadway.

13. The driver assistance system as recited in claim 8, wherein the acquisition device includes a telematics receiving device.

14. The driver assistance system as recited in claim 8, wherein the acquisition device includes a video sensor apparatus for recognizing a town entry sign and a town exit sign.
